(19) United States
(12) Patent Application Publication
(10) Pub. No.: US 2025/0083393 A1
(43) Pub. Date: Mar. 13, 2025

(54) METHOD AND SYSTEM FOR ADDITIVE MANUFACTURING

(71) Applicant: GM GLOBAL TECHNOLOGY OPERATIONS LLC, Detroit, MI (US)

(72) Inventors: Mitchell Patterson, Richmond, MI (US); Adam McFarland, Royal Oak, MI (US); Steven Lewis Corzyk, Farmington Hills, MI (US); Zachary Paul Steffes, West Bloomfield, MI (US)

(73) Assignee: GM GLOBAL TECHNOLOGY OPERATIONS LLC, Detroit, MI (US)

(21) Appl. No.: 18/464,406

(22) Filed: Sep. 11, 2023

(51) Int. Cl. B29C 64/393; B29C 64/153; B33Y 10/00; B33Y 30/00; B33Y 50/00

(52) U.S. Cl. CPC B29C 64/393; B29C 64/153; B33Y 10/00; B33Y 30/00; B33Y 50/00

(57) ABSTRACT

A system for additive manufacturing a component includes the component configured to be additively manufactured using powder bed fusion. The component includes a first geometry that is different than a second geometry, and the first geometry and the second geometry are configured to create a thermal gradient along the component. The system includes a thermal management structure defined proximate the component. The thermal management structure has a first structure geometry that is different than a second structure geometry. The first structure geometry is defined proximate the first geometry and the second structure geometry is defined proximate the second geometry. The thermal management structure is configured to be additively manufactured with the component substantially simultaneously to reduce the thermal gradient along the component.

### INTRODUCTION

The technical field generally relates to a method and system for additive manufacturing, and more particularly relates to a method and system for additive manufacturing components with a reduced thermal gradient to improve component printability and quality.

Additive manufacturing may be used to form various components. In the example of powder bed fusion, an energy source may be used to fuse powder to form the component layer by layer. In certain instances, a component to be formed via additive manufacturing may have a complex geometry, with variable wall thicknesses, apertures, etc. The complex geometry of the component may result in large changes in temperature along the component during manufacturing. These large variations in temperature along the component or a large temperature gradient along the component is undesirable.

Accordingly, it is desirable to provide a method and system for additive manufacturing, which enables the formation of a component having a complex geometry with a reduced thermal gradient along the component, thereby improving component printability and quality. Furthermore, other desirable features and characteristics of the present invention will become apparent from the subsequent detailed description and the appended claims, taken in conjunction with the accompanying drawings and the foregoing technical field and background.

### SUMMARY

According to various embodiments, provided is a system for additive manufacturing a component. The system includes the component configured to be additively manufactured using powder bed fusion. The component includes a first geometry that is different than a second geometry, and the first geometry and the second geometry are configured to create a thermal gradient along the component. The system includes a thermal management structure defined proximate the component. The thermal management structure has a first structure geometry that is different than a second structure geometry. The first structure geometry is defined proximate the first geometry and the second structure geometry is defined proximate the second geometry. The thermal management structure is configured to be additively manufactured with the component substantially simultaneously to reduce the thermal gradient along the component.

The thermal management structure is a solid structure. The first geometry is a first wall thickness, the second geometry is a second wall thickness, the first structure geometry is a first structure wall thickness and the second structure geometry is a second structure wall thickness. The first wall thickness is greater than the second wall thickness, and the first structure wall thickness is less than the second structure wall thickness. The component defines a central bore, and the thermal management structure includes a first structure positioned within the central bore and a second structure positioned about an outer surface of the component. The thermal management structure surrounds at least a portion of an outer surface of the component. The thermal management structure encloses the component. The thermal management structure is a lattice having a plurality of cells. The first geometry is a first wall thickness, the second geometry is a second wall thickness, the first structure geometry is a first density of the plurality of cells and the second structure geometry is a second density of the plurality of cells. The first wall thickness is greater than the second wall thickness, and the first density of the plurality of cells is less than the second density of the plurality of cells. The first geometry is a first wall thickness, the second geometry is a second wall thickness, the first structure geometry is a first distance defined between at least one of the plurality of cells and the second structure geometry is a second distance defined between at least a second one of the plurality of cells. The first wall thickness is greater than the second wall thickness, and the first distance defined between at least one of the plurality of cells is greater than the second distance defined between at least one of the plurality of cells. The first geometry is a first wall thickness, the second geometry is a second wall thickness, the first structure geometry is a first cell wall thickness of at least one of the plurality of cells and the second structure geometry is a second cell wall thickness of at least a second one of the plurality of cells. The first wall thickness is greater than the second wall thickness, and the first cell wall thickness is less than the second cell wall thickness. The powder bed fusion is performed by a multi jet fusion three-dimensional printer, and the component and the thermal management structure are composed of a polymer-based material.

Also provided is a method for additive manufacturing a component. The method includes receiving, by a processor of a controller, data of the component to be additively manufactured using powder bed fusion. The data includes a model of the component. The component includes a first geometry different than a second geometry, and the first geometry and the second geometry are configured to create a thermal gradient along the component. The method includes defining a thermal management structure based on the thermal gradient to reduce the thermal gradient. The thermal management structure is defined to surround at least a portion of the component. The thermal management structure has a first structure geometry that is different than a second structure geometry, with the first structure geometry defined proximate the first geometry and the second structure geometry defined proximate the second geometry. The method includes outputting one or more control signals, by the controller, to additively manufacture the component with the thermal management structure using the powder bed fusion.

The thermal management structure is a solid structure. The thermal management structure is a lattice structure. The powder bed fusion is performed by a multi jet fusion three-dimensional printer, and the component and the thermal management structure are each comprised of a polymer-based material. The first geometry is a first wall thickness, the second geometry is a second wall thickness that is less than the first wall thickness, the first structure geometry is a first structure wall thickness and the second structure geometry is a second structure wall thickness that is greater than the first structure wall thickness.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a system for additive manufacturing an exemplary component with a reduced thermal gradient, in accordance with various embodiments;

FIG. 2 is a perspective view of an exemplary build box that is manufactured by the system of FIG. 1, in accordance with various embodiments;

FIG. 3 is a perspective view of the exemplary component and an exemplary thermal management structure additively manufactured using the system of FIG. 1, in accordance with various embodiments;

FIG. 4 is a cross-sectional view of the component and the thermal management structure of FIG. 3, taken along line 4-4 of FIG. 3,

FIG. 5A is a top view of the component and the thermal management structure of FIG. 3;

FIG. 5B is a cross-sectional view of the component and the thermal management structure of FIG. 3, taken along line 5B-5B of FIG. 3;

FIG. 5C is a bottom view of the component and the thermal management structure of FIG. 3;

FIG. 6 is a graph that illustrates a thermal gradient of the component during manufacture by the system of FIG. 1, in which a y-axis is the temperature in degrees Celsius and an x-axis is a percentage of a length of the component from a top surface (0%) to a bottom surface (100%), in accordance with various embodiments;

FIG. 7 is a perspective view of another exemplary component and another exemplary thermal management structure additively manufactured using the system of FIG. 1, in accordance with various embodiments:

FIG. 8 is a cross-sectional view of the component and the thermal management structure of FIG. 7, taken along line 8-8 of FIG. 7;

FIG. 9 is a detail view of FIG. 8, taken at 9 on FIG. 8; and

FIG. 10 is a flowchart illustrating a method of additive manufacturing of the component, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. For the sake of brevity, conventional techniques related to signal processing, data transmission, signaling, control, machine learning models, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein are merely exemplary embodiments of the present disclosure.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “about” denotes within 10% to account for manufacturing tolerances. In addition, the term “substantially” denotes within 10% to account for manufacturing tolerances.

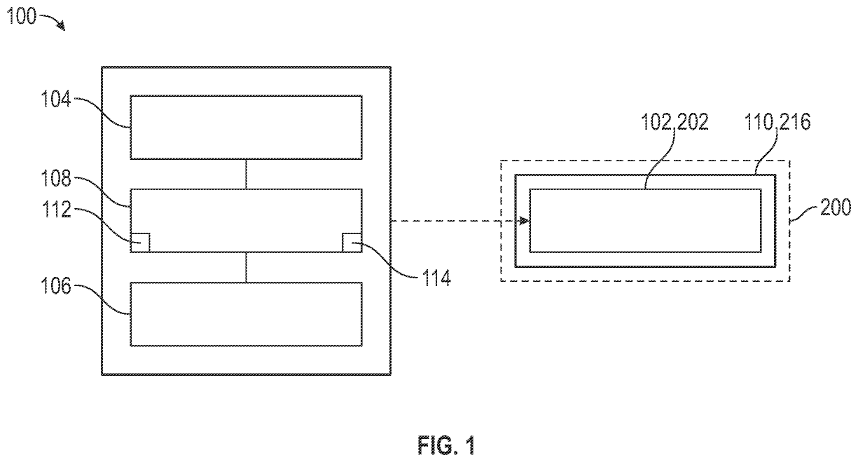

With reference to FIG. 1, a system for additive manufacturing is shown generally as 100 in accordance with various embodiments. In this example, the system 100 enables the additive manufacture of a component 102, 202 with complex geometry with a reduced thermal gradient. By reducing the thermal gradient, the component 102, 202 may be additively manufactured with improved printability and quality. In this example, the component 102, 202 is additively manufactured from a polymer-based material, including, but not limited to polypropylene, and is additively manufactured using powder bed fusion. It should be noted, however, that the system 100 and component 102, 202 are not limited to polypropylene and powder bed fusion, but rather, the various teachings of the present disclosure may be applied to any suitable polymer-based material and additive manufacturing process.

In one example, the system 100 includes a human-machine interface 104, a powder bed fusion system 106 and a controller 108. It should be noted that the human-machine interface 104 and the controller 108 may all be part of the powder bed fusion system 106 and need not be separate components. The human-machine interface 104 is in communication with the controller 108 via a suitable communication medium, such as a communication bus. The human-machine interface 104 may be configured in a variety of ways. In some embodiments, the human-machine interface 104 may include various input devices, such as switches or levers, one or more buttons, a touchscreen interface that may be overlaid on a display, a keyboard, an audible device, a microphone associated with a speech recognition system, or various other human-machine interface devices. Generally, the human-machine interface 104 receives data from a user, including, but not limited to data of dimensions associated with the component 102, 202, data of a processing temperature window associated with the powder in the powder bed fusion system 106, etc. In the example of the polymer-based powder material as polypropylene, polypropylene has a processing temperature window of about 165 degrees Celsius plus or minus about 10 degrees Celsius. Thus, in order to fuse each cross-sectional slice, the powder is heated to the temperature of the processing window associated with the powder in the powder bed. In certain instances, the human-machine interface 104 also receives data of the thermal management structure 110, 216 associated with the component 102, 202 to minimize the thermal gradients experienced by the component 102, 202 during manufacture.

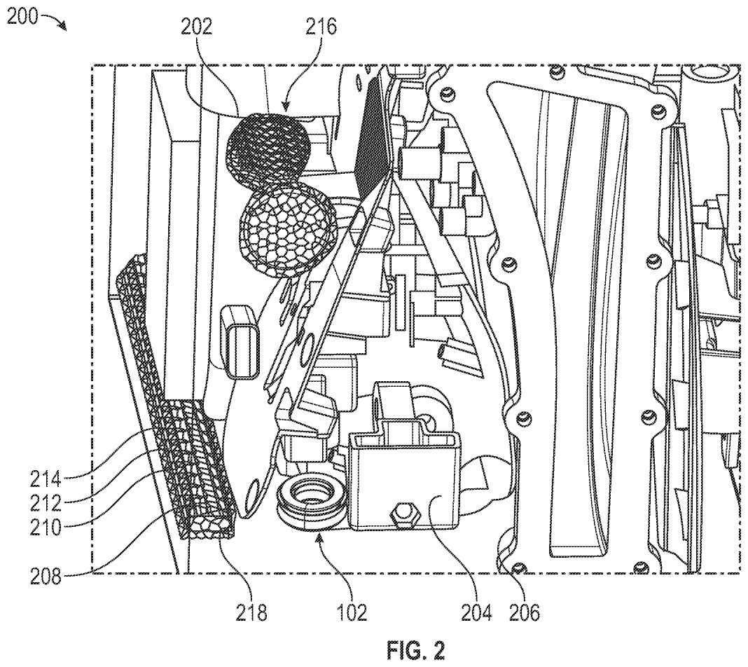

In certain examples, with brief reference to FIG. 2, the data of the component 102 and the data of the thermal management structure 110 may be included as a build of various components within a build box 200, such as components 202-214, etc. In this example, the component 202 also includes a thermal management structure 216, as will be discussed below. The components 208-214 are enclosed within a box 218. The box 218 ensures that the components 208-214, which each comprise a U-shaped flange that are smaller in size than the components 202-206, remain contained within the build box 200 during manufacturing. Stated another way, the box 218 acts as a package to enable the smaller components 208-214 to be manufactured with larger components 202-206 in the same manufacturing process, which assists in optimizing build space within the build box 200. In contrast, as will be discussed, the thermal management structure 110, 216 ensures that the thermal gradients experienced by the respective components 102, 202 is substantially uniform to improve quality of the components 102, 202. Generally, the components 102, 202-214, the box 218 and the thermal management structures 110, 216 within the build box 200 are manufactured or printed substantially simultaneously layer by layer using the powder bed fusion system 106. For example, the data of the components 102, 202-214, the box 218 and the thermal management structures 110, 216 within the build box 200 may be designed with computer aided design (CAD) software as a model and may include three-dimensional (3D) numeric coordinates of the entire configuration including both external and internal surfaces. In one exemplary embodiment, the model may include a number of successive two-dimensional (2D) cross-sectional slices that together form the 3D components 102, 202-214, the box 218 and the thermal management structures 110, 216 within the build box 200.

With reference back to FIG. 1, the powder bed fusion system 106 is configured to receive the data input via the human-machine interface 104 and is controlled via the controller 108 to manufacture the component 102, 202 including the thermal management structure 110, 216 within the build box 200. The powder bed fusion system 106 is in communication with the controller 108, via a suitable communication architecture, such as a communication bus, to receive one or more control signals from the controller 108. In one example, the powder bed fusion system 106 is a commercially available powder bed fusion system 106. For example, the powder bed fusion system 106 includes, but is not limited to, a multi jet fusion three-dimensional (3D) printer. It should be noted that in other examples, the powder bed fusion system 106 may comprise a selective laser melting (SLM) 3D printer, a selective laser sintering (SLS) 3D printer, etc.

Briefly, in the example of the powder bed fusion system 106 as the multi jet fusion 3D printer, the powder bed fusion system 106 includes a fabrication device, a powder delivery device, an infrared energy source, and a fusing agent supplied by at least one or a plurality of movable printer heads, which cooperate to manufacture the components 102, 202-214, the box 218 and the thermal management structures 110, 216 within the build box 200 with the polymer-based build material, such as the polypropylene. The fabrication device includes a build container with a fabrication support on which the build box 200 is formed and supported. The fabrication support is movable within the build container in a vertical direction and is adjusted in such a way to define a working plane. The powder delivery device includes a powder chamber with a delivery support that supports the build material and is also movable in the vertical direction. The powder delivery device further includes a roller or wiper that transfers build material from the powder delivery device to the fabrication device.

Generally, during operation, the roller or wiper scrapes or otherwise pushes a portion of the build material from the powder delivery device to form the working plane in the fabrication device. The printer head deposits the fusing agent to selectively fuse the build material into a cross-sectional layer of the build box 200 according to the design. Generally, the speed, position, and other operating parameters of the printer head are controlled by the controller 108 to selectively fuse the powder of the build material into larger structures. Once the fusing agent is deposited onto the powder particles to form a layer, the infrared energy source, such as an infrared lamp, is activated by the controller 108 to solidify and consolidate the fusing agent, and thus, the powder particles into a solid structure. As such, based on the control of the printer heads, each layer of build material may include un-fused and fused build material that respectively corresponds to the respective cross-section that forms the components 102, 202-214, the box 218 and the thermal management structures 110, 216 within the build box 200.

Upon completion of a respective layer, the roller or wiper again pushes a portion of the build material from the powder delivery device to form an additional layer of build material on the working plane of the fabrication device. The printer heads are movably supported relative to the build box 200 and are again controlled by the controller 108 to selectively form another cross-sectional layer. As such, the components 102, 202-214, the box 218 and the thermal management structures 110, 216 within the build box 200 are positioned in a bed of build material as the successive layers are formed such that the un-fused and fused material supports subsequent layers. This process is continued according to the modeled design as successive cross-sectional layers are formed into the completed components 102, 202-214, the box 218 and the thermal management structures 110, 216 within the build box 200.

The controller 108 includes at least one processor 112 and a computer-readable storage device or media 114. The processor 112 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 108, a semiconductor-based microprocessor (in the form of a microchip or chip set), any combination thereof, or generally any device for executing instructions. The computer readable storage device or media 114 may include volatile and nonvolatile storage in read-only memory (ROM), random-access memory (RAM), and keep-alive memory (KAM), for example. KAM is a persistent or non-volatile memory that may be used to store various operating variables while the processor 112 is powered down. The computer-readable storage device or media 114 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 108 in controlling the powder bed fusion system 106 to form the component 102, 202 and the thermal management structure 110, 216.

With reference to FIG. 2, the components 102, 202 are each manufactured with the respective thermal management structure 110, 216, which surrounds the individual component 102, 202. The thermal management structure 110, 216 minimizes the thermal gradient experienced by the component 102, 202 during manufacturing by the powder bed fusion system 106.

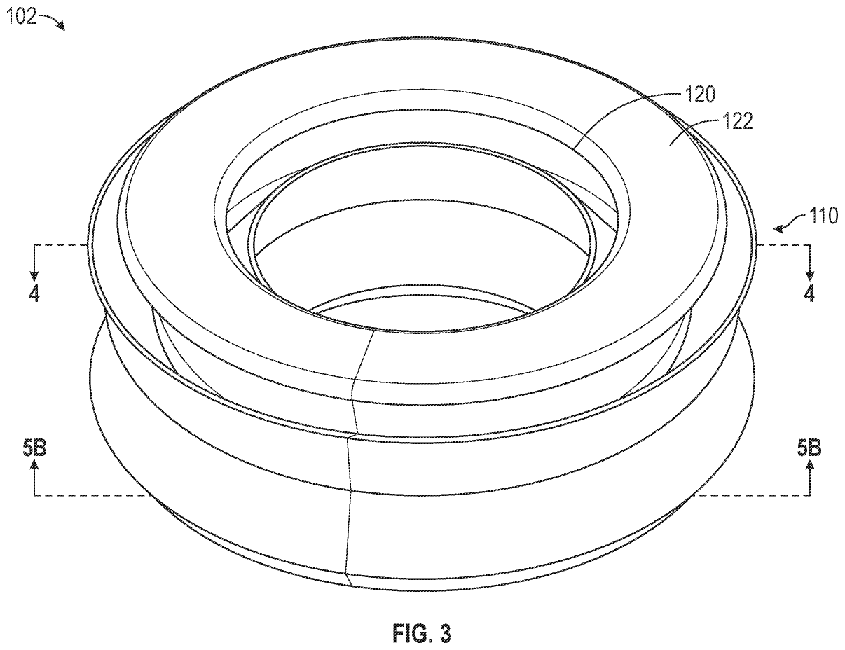

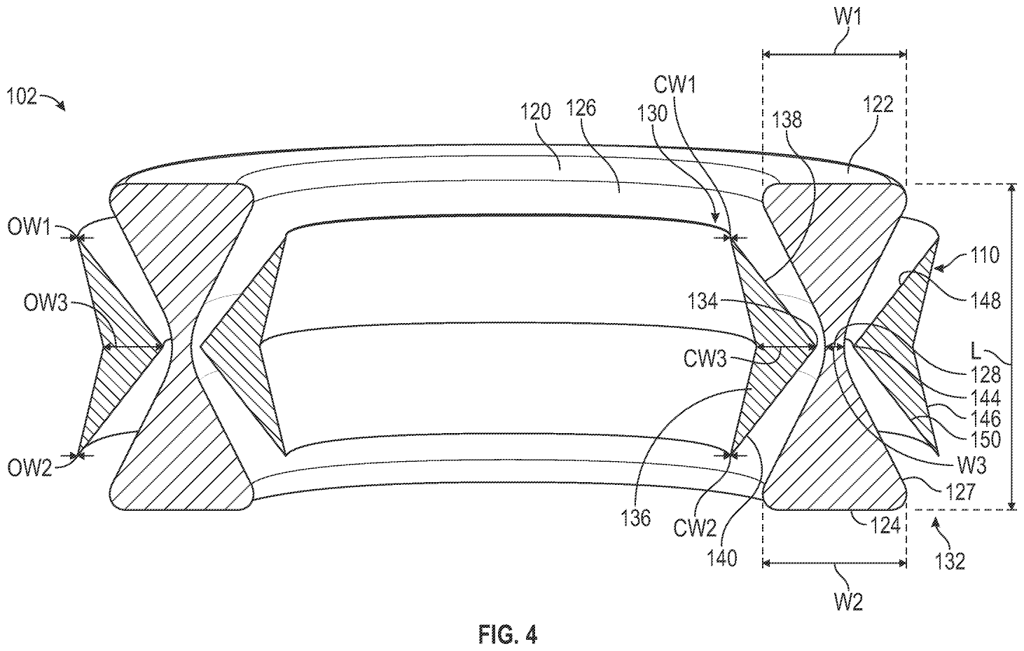

Referring to FIGS. 3 and 4, the component 102 and the thermal management structure 110 are shown in greater detail. In this example, the component 102 is substantially annular, and defines a central opening 120. The central opening 120 extends through the component 102 from a first, top surface 122 to an opposite second, bottom surface 124. A first, inner sidewall 126 interconnects the top surface 122 and the bottom surface 124 and defines the central opening 120. A second, outer sidewall 127 interconnects the top surface 122 and the bottom surface 124 and defines an outer perimeter of the component 102. In this example, the component 102 has a non-uniform cross-section, which is substantially bourglass in shape. Generally, a first wall thickness W1 of the component 102 at the top surface 122 is substantially the same as a second wall thickness W2 of the component 102 at the bottom surface 124. A third wall thickness W2 is defined at a midsection 128 that is equidistant between the top surface 122 and the bottom surface 124 is different and less than the first wall thickness W1 and the second wall thickness W2. In one example, the first wall thickness W1 is about 20 millimeters (mm), the second wall thickness W2 is about 20 millimeters (mm) and the third wall thickness W3 is about 5 millimeters (rom). Thus, stated another way, the component 102 has a first geometry (the first wall thickness W1) at a first portion (the top surface 122) that is different than a second geometry (the third wall thickness W3) at a second portion (the midsection 128). The component 102 also has a third geometry (the second wall thickness W2) that is different than the second geometry at the second portion.

Without the thermal management structure 110, the difference between the first wall thickness W1, the second wall thickness W2 and the third wall thickness W3 would create a large thermal gradient across the component 102 as the component 102 is manufactured, which may also result in the portion of the component 102 proximate the third wall thickness W3 being at a temperature below the processing window for the powder in the powder bed fusion system 106. Stated another way, the thermal gradient experienced by the component 102 is defined as a change in temperature over a length L of the component 102 between the top surface 122 and the bottom surface 124. As the third wall thickness W3 is different and less than the first wall thickness W1 and the second wall thickness W2, the midsection 128 has a third temperature T3. In one example, the third temperature T3 is about ISS degrees Celsius without the thermal management structure 110, which is below the processing temperature window for the powder (polypropylene in this example) in the powder bed fusion system 106. The third temperature T3 is different and less than a first temperature T1 at the top surface 122 and a second temperature T2 at the bottom surface 124. In one example, the first temperature T1 and the second temperature T2 are each about 175 degrees Celsius without the thermal management structure 110. This change or difference in temperature along the length L of the component 102 (about 175 degrees Celsius to about 155 degrees Celsius to about 175 degrees Celsius) is undesirable and may result in warping, lifting and unintentional surface roughness.

The use of the thermal management structure 110, however, reduces the thermal gradient along the length L by increasing a temperature around the midsection 128. In one example, the thermal management structure 110 includes an inner structure 130 and an outer structure 132. In this example, due to the substantially uniform temperature along the top surface 122 and the bottom surface 124, the thermal management structure 110 is circumferentially open and does not enclose an entirety of a perimeter of the component 102. In other examples, a thermal management structure may be enclosed so as to surround the component under manufacture to reduce the temperature gradient. The inner structure 130 is substantially triangular in cross-section. The inner structure 130 has an apex 134 defined proximate the midsection 128, and a base 136 defined opposite the apex 134 that forms an inner perimeter of the inner structure 130. A first inner sidewall 138 interconnects the apex 134 and the base 136, and a second inner sidewall 140 interconnects the apex 134 and the base 136. The first inner sidewall 138 is defined to extend outwardly from the apex 134 toward the top surface 122. The second inner sidewall 140 is defined to extend outwardly from the apex 134 toward the bottom surface 124. In this example, the base 136 is indented radially inward, however, the base 136 may be planar.

The inner structure 130 is defined to manage the thermal gradient along the inner perimeter or circumference of the component 102. The inner structure 130 has a first inner wall thickness CW1 defined between the first inner sidewall 138 and the base 136 proximate the top surface 122 that is substantially the same as a second inner wall thickness CW2 defined between the second inner sidewall 140 and the base 136 proximate the bottom surface 124. The inner structure 130 has a third inner wall thickness CW3 that is different and greater than the first inner wall thickness CW1 and the second inner wall thickness CW2. In one example, the first inner wall thickness CW1 is about 1.0 millimeter (mm), the second inner wall thickness CW2 is about 1.0 millimeter (mm) and the third inner wall thickness CW3 is about 10.0 millimeters (mm). By providing the inner structure 130 with the third inner wall thickness CW3 at the midsection 128, the heat generated during the fusing of the inner structure 130 beats the midsection 128 of the component 102 along the inner sidewall 126 of the component 102, which reduces the thermal gradient associated with the component 102 and ensures that the midsection 128 remains within the processing temperature window for the powder in the powder bed fusion system 106. As the component 102 increases in wall thickness from the third wall thickness W3 to the first wall thickness W1, the inner structure 130 decreases in wall thickness from the third inner wall thickness CW3 to the first inner wall thickness CW1 so as to not impact the temperature of the inner sidewall 126 proximate the top surface 122. Similarly, as the component 102 increases in wall thickness from the third wall thickness W3 to the second wall thickness W2, the inner structure 130 decreases in wall thickness from the third ioner wall thickness CW3 to the second inner wall thickness CW2 so as to not impact the temperature of the inner sidewall 126 proximate the bottom surface 124. In addition, as each of the inner sidewalls 138, 140 extend at an angle from the apex 134, the inner sidewalls 138, 140 are spaced apart from the inner sidewall 126, which provides an air gap to dissipate beat between the inner structure 130 and the inner sidewall 126 of the component 102. The air gap increases toward the respective one of the top surface 122 and the bottom surface 124, which further assists in maintaining the temperature along the inner sidewall 126.

The outer structure 132 is substantially triangular in cross-section, and in one example, is a mirror image of the inner structure 130. The outer structure 132 has an apex 144 defined proximate the midsection 128, and a base 146 defined opposite the apex 144 that forms an inner perimeter of the outer structure 132. A first outer sidewall 148 interconnects the apex 144 and the base 146, and a second outer sidewall 150 interconnects the apex 144 and the base 146. The first outer sidewall 148 is defined to extend outwardly from the apex 144 toward the top surface 122. The second outer sidewall 150 is defined to extend outwardly from the apex 144 toward the bottom surface 124. In this example, the base 146 is indented radially inward, however, the base 146 may be planar.

The outer structure 132 is defined to manage the thermal gradient along the outer perimeter or circumference of the component 102. The outer structure 132 has a first outer wall thickness OW1 defined between the first outer sidewall 148 and the base 146 proximate the top surface 122 that is substantially the same as a second outer wall thickness OW2 defined between the second outer sidewall 150 and the base 146 proximate the bottom surface 124. The outer structure 132 has a third outer wall thickness OW3 that is different and greater than the first outer wall thickness OW1 and the second outer wall thickness OW2. In one example, the first outer wall thickness OW1 is about 0.5 millimeters (mm), the second outer wall thickness OW2 is about 0.5 millimeters (mm) and the third wall thickness OW3 is about 10 millimeters (mm). By providing the outer structure 132 with the third outer wall thickness OW3 at the midsection 128, the heat generated during the fusing of the outer structure 132 heats the midsection 128 of the component 102 along the outer sidewall 127 of the component 102, which reduces the thermal gradient associated with the component 102. As the component 102 increases in wall thickness from the third wall thickness W3 to the first wall thickness W1, the outer structure 132 decreases in wall thickness from the third outer wall thickness OW3 to the first outer wall thickness OW1 so as to not impact the temperature of the outer sidewall 127 proximate the top surface 122. Similarly, as the component 102 increases in wall thickness from the third wall thickness W3 to the second wall thickness W2, the outer structure 132 decreases in wall thickness from the third outer wall thickness OW3 to the second outer wall thickness OW2 so as to not impact the temperature of the outer sidewall 127 proximate the bottom surface 124. In addition, as each of the outer sidewalls 148, 150 extend at an angle from the apex 144, the outer sidewalls 148, 150 are spaced apart from the outer sidewall 127, which provides an air gap to dissipate heat between the outer structure 132 and the outer sidewall 127 of the component 102. The air gap increases toward the respective one of the top surface 122 and the bottom surface 124, which further assists in maintaining the temperature along the outer sidewall 127. Generally, the thermal management structure 110 has a first geometry (the first inner wall thickness CW1; the first outer wall thickness OW1) at a first portion that is different than a second geometry (the third inner wall thickness CW3; third outer wall thickness OW3) at a second portion. The thermal management structure 110 also has a third geometry (the second inner wall thickness CW2; second outer wall thickness OW2) that is different than the second geometry at the second portion.

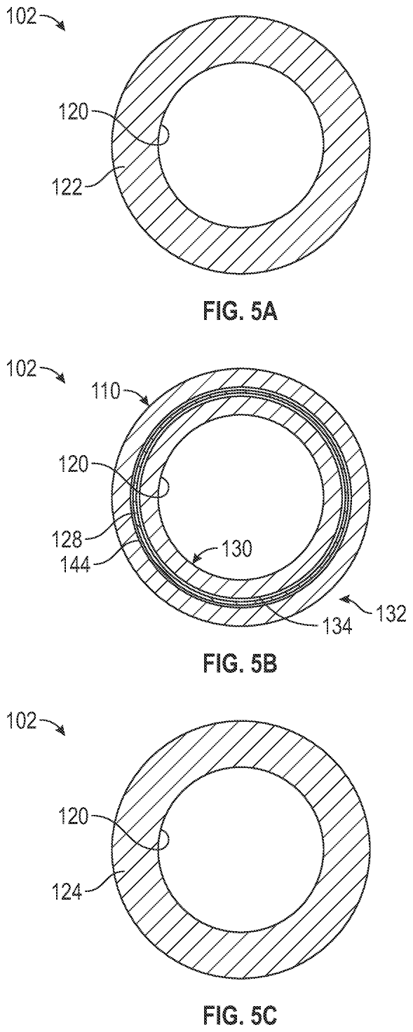

With reference to FIGS. SA-SC, the component 102 and the thermal management structure 110 are shown. In FIG. 5A, a top view of the component 102, the inner structure 130 and the outer structure 132 is shown. As the top surface 122 has a large uniform surface area, the inner structure 130 and the outer structure 132 are not necessary to manage the temperature along the top surface 122. With reference to FIG. 5B, a cross-section through the midsection 128 of the component 102, and the apexes 134, 144 of the respective inner structure 130 and outer structure 132 is shown. As shown, the ioner structure 130 and the outer structure 132 provide additional surface area that results in the midsection 128, the inner structure 130 and the outer structure 132 having a surface area that is substantially similar to the surface area of the top surface 122 (FIG. 5A), which reduces the thermal gradient or changes in temperature along the component 102. In FIG. SC, a bottom view of the component 102, the inner structure 130 and the outer structure 132 is shown. As the bottom surface 124 has a large uniform surface area, the inner structure 130 and the outer structure 132 are not necessary to manage the temperature along the top surface 122.

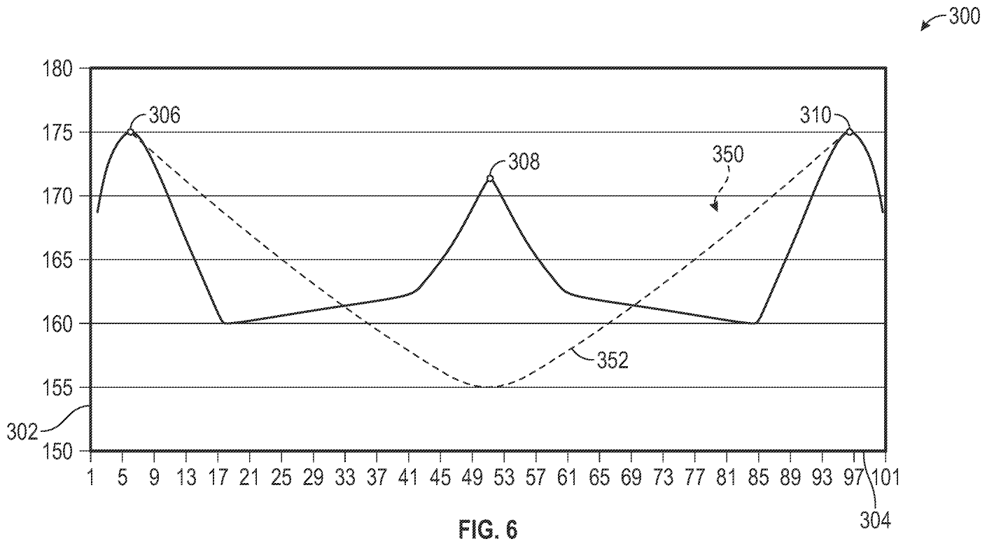

By additively manufacturing the component 102 with the thermal management structure 110, with reference to FIG. 6, the thermal gradient along the component 102 is reduced. FIG. 6 is a graph of the temperature of the component 102 both with and without the thermal management structure 110. In this example, the thermal gradient observed along the component 102 is graphically illustrated with a line 300. The line 300 is the thermal gradient observed when the component 102 is additively manufactured using the thermal management structure 110. A y-axis 302 is the temperature in degrees Celsius, and an x-axis 304 is a percentage of the length L of the component 102 from the top surface 122 (0%) to the bottom surface 124 (100%). A point 306 on the line 300 is proximate the top surface 122 of the component 102, the point 308 on the line 300 denotes the midsection 128 and the point 310 on the line 300 is proximate the bottom surface 124. A line 350 denotes the thermal gradient observed when the component 102 is additively manufactured without the thermal management structure 110. A point 352 on the line 350 denotes the midsection 128. As shown, the use of the thermal management structure 110 reduces the changes in temperature along the length L of the component 102, which improves a quality of the component 102. In this example, the midsection 128 has a third temperature T3′ with the thermal management structure 110, which is about 172 degrees Celsius. The third temperature T3′ is different and less than a first temperature T1′ at the top surface 122 and a second temperature T2′ at the bottom surface 124. In one example, the first temperature T1′ and the second temperature T2′ are each about 175 degrees Celsius with the thermal management structure 110. Thus, by manufacturing the component 102 with the thermal management structure 110, the thermal gradient of the component 102 is reduced as the temperature T3′ at the midsection within less than 5% of the temperature T1′, T2′ of the surfaces 122, 124. It should be noted that the values used herein are merely examples.

It should be noted that in certain instances, the desired predetermined temperature for printing the component 102 may be a subrange of temperatures within a processing temperature window. In this example, the desired predetermined temperature of the component 102 is about 175 degrees Celsius as this results in the component 102 being formed with improved mechanical properties compared to a component manufactured at higher temperatures (temperatures above about 175 degrees Celsius). Thus, in this instance, the predetermined acceptable change or difference in temperature along the length L of the component 102 or predetermined acceptable thermal gradient is about negative IS degrees Celsius to about zero degrees Celsius (or about 160 degrees Celsius to about 175 degrees Celsius).

In this example, the thermal management structure 110 is solid and has the wall thickness CW1-CW3, OW1-OW3 that varies in conjunction with a distance that the respective one of the inner structure 130 and the outer structure 132 are from the component 102, which results in a reduced temperature gradient over the component 102. While the thermal management structure 110 associated with the component 102 is shown and described herein as a solid component, the component 102 may be manufactured with a thermal management structure that is composed of a lattice, similar to the thermal management structure 216.

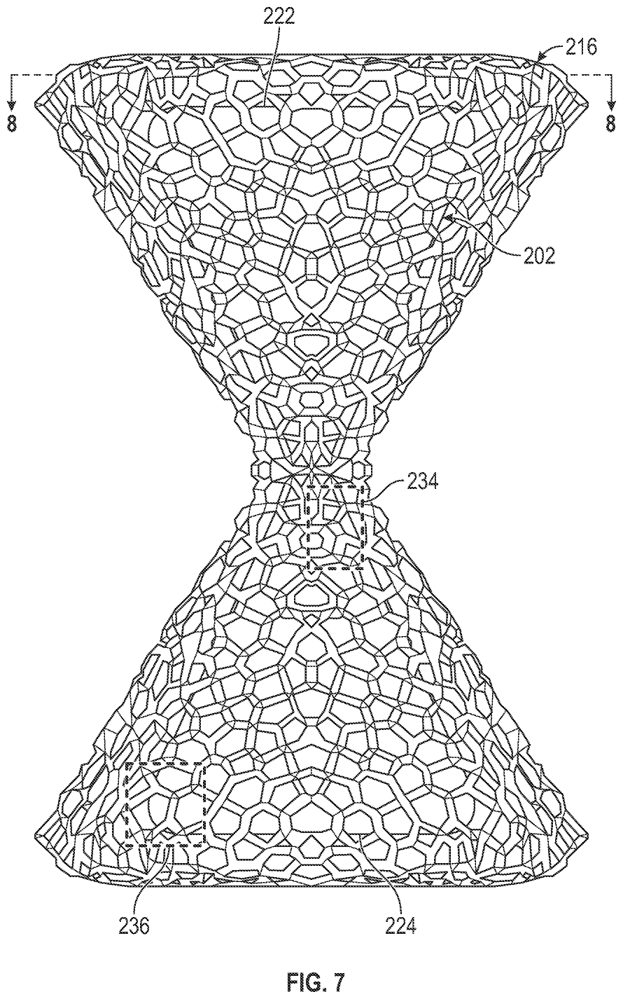

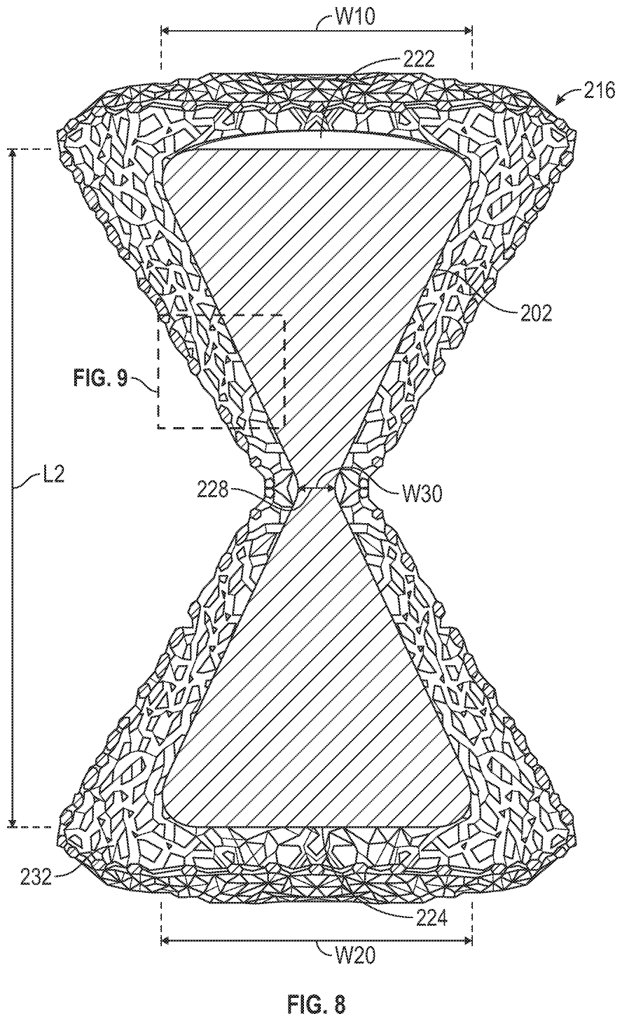

With reference to FIG. 7, the thermal management structure 216 associated with the component 202 is shown in greater detail. In this example, the component 202 is solid, and is substantially hourglass in shape. The component 202 has a first, top surface 222 and an opposite second, bottom surface 224. A sidewall 226 interconnects the top surface 222 and the bottom surface 224 about a perimeter of the component 202. With reference to FIG. 8, the component 202 has a non-uniform cross-section, which is substantially hourglass in shape. Generally, a first wall thickness W10 of the component 202 at the top surface 222 is substantially the same as a second width W20 of the component 202 at the bottom surface 224. A third wall thickness W30 defined at a midsection 228 that is equidistant between the top surface 222 and the bottom surface 224 is different and less than the first wall thickness W10 and the second wall thickness W20. In one example, the first wall thickness W10 is about 20 millimeters (mm), the second wall thickness W20 is about 20 millimeters (mm) and the third wall thickness W30 is about 5 millimeters (mm). Thus, stated another way, the component 202 has a first geometry (the first wall thickness W10) at a first portion (the top surface 222) that is different than a second geometry (the third wall thickness W30) at a second portion (the midsection 228). The component 202 also has a third geometry (the second wall thickness W20) that is different than the second geometry at the second portion.

Without the thermal management structure 216, the difference between the first wall thickness W10, the second wall thickness W20 and the third wall thickness W30 would create a thermal gradient across the component 202 as the component 202 is manufactured, which may also result in the portion of the component 202 proximate the third wall thickness W30 being at a temperature below the processing window for the powder in the powder bed fusion system 106. Stated another way, the thermal gradient experienced by the component 202 is defined as the change in temperature over a length L2 of the component 202 between the top surface 222 and the bottom surface 224. As the third wall thickness W30 is different and less than the first wall thickness W10 and the second wall thickness W20, the midsection 228 has a third temperature T30. In one example, the third temperature T30 is about 155 degrees Celsius without the thermal management structure 216, which is below the processing temperature window for the powder (polypropene in this example) of the powder bed fusion system 106. The third temperature T30 is different and less than a first temperature T10 at the top surface 122 and a second temperature T20 at the bottom surface 224. In one example, the first temperature T10 and the second temperature T20 are each about 175 degrees Celsius without the thermal management structure 216. This change or difference in temperature along the length L2 of the component 202 is undesirable and may result in warping, lifting and unintentional surface roughness.

The use of the thermal management structure 216, however, reduces the thermal gradient along the length L2 by increasing a temperature around the midsection 228. In this example, the thermal management structure 216 is composed of a lattice 230, which encloses the component 202. The lattice 230 includes a plurality of interconnected cells 232, which cooperate to enclose the component 202 during manufacture. The cells 232 of the lattice 230 are open, such that less material may be used to form the thermal management structure 216. Generally, the lattice 230 is defined to reduce the thermal gradient along the component 202.

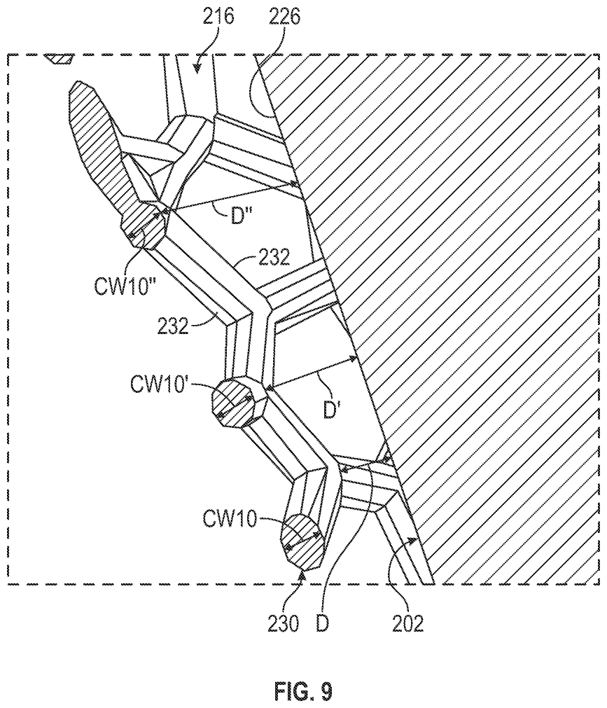

With reference to FIG. 9, each cell 232 of the lattice 230 has a cell wall thickness CW10. In order to accommodate the different wall thicknesses W10, W20, W30, the cell wall thickness CW10 may vary. For example, the cell wall thickness CW10′ of one of the cells 232 is different and greater than a cell wall thickness CW10″ of another one of the cells 232. As the cell 232 with the cell wall thickness CW10″ is spaced further from the midsection 228 and is positioned proximate a portion of the component 202 with a greater wall thickness, the cell wall thickness CW10″ may be reduced to manage the thermal gradient along the component 202. In addition, a distance D of each cell 232 to the component 202 may be varied to manage the thermal gradient. For example, the distance D′ of the cell 232 is different and less than the distance D″ of another cell 232. As the cell 232 with the distance D″ is spaced further from the midsection 228 and is positioned proximate a portion of the component 202 with a greater wall thickness, the distance D″ may be increased to define a larger air gap between the lattice 230 and the component 202 to manage the thermal gradient along the component 202.

In addition, with reference back to FIG. 7, a density of the cells 232 may vary to reduce the thermal gradient experienced by the component 202. For example, a first subregion 234 of the cells 232 proximate the midsection 228 may have a density that is different and greater than a density of a second subregion 236 of the cells 232 proximate the bottom surface 224. As the second subregion 236 is spaced further from the midsection 228 and is positioned proximate a portion of the component 202 with a greater wall thickness, the density of the second subregion 236 may be reduced to manage the thermal gradient along the component 202. Thus, by varying the cell wall thickness CW10, the distance between the cells 232 and the component 202 and/or the density of the cells 232 of the lattice 230, the thermal gradient experienced by the component 202 may be reduced. Generally, the thermal management structure 216 has a first geometry (the cell wall thickness CW10′; the distance D′; the first subregion 234) at a first portion that is different than a second geometry (the cell wall thickness CW10″; the distance D″; the second subregion 236) at a second portion. In one example, the cell wall thickness CW10 is about 0.5 millimeters (mm) to about 10 millimeters (mm), and the distance D is about 2 millimeters (mm) to about 50 millimeters (mm). The density of the cells 232 may vary based on the predetermined temperature gradient from about 100% dense (solid part) to about 0% dense, and in this example, the density of the cells 232 is about 5 cells 232 to about 15 cells per 100 millimeters (mm).

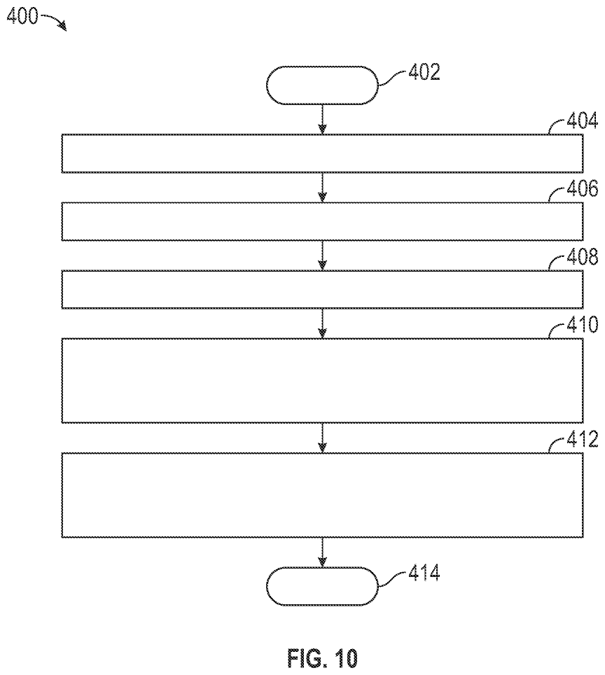

With reference to FIG. 10, and with continued reference to FIGS. 1-9, a method 400 for additive manufacturing of a component with a reduced thermal gradient that may be performed by the system 100 is shown in accordance with various embodiments. As can be appreciated in light of the disclosure, the order of operation within the method 400 is not limited to the sequential execution as illustrated in FIG. 10, but may be performed in one or more varying orders as applicable and in accordance with the present disclosure.

At 402, the method 400 begins. At 404, the method 400 includes receiving or providing data of the component 102, 202 via the human-machine interface 104, for example, to the controller 108. The data may include, but is not limited to, the model having a number of successive two-dimensional (2D) cross-sectional slices that together form the 3D components 102, 202. At 406, the method 400 includes receiving or providing data of the processing temperature window for the powder in the powder bed fusion system 106 via the human-machine interface 104, for example, to the controller 108. For example, for polypropylene, the processing temperature window is about 165 degrees Celsius plus or minus about 10 degrees Celsius. The method 400 may also include receiving, via the human-machine interface 104, the predefined acceptable processing temperature window. At 408, the method 400 includes determining the thermal gradient of the component 102, 202. For example, one or more computer aided thermodynamic design tools may be employed to determine the thermal gradient of the component 102, 202 layer by layer based on the data of the component 102, 202 and the processing temperature window for the powder, including, but not limited to TAITherm™ by ThermoAnalytics, Inc. of Altair Engineering, Inc. of Troy, Mi., Autodesk, Inc. of San Francisco, CA, etc.

At 410, the method 400 includes defining the thermal management structure 110, 216 to reduce the temperature gradient associated with the component 102, 202 and to ensure that the component 102, 202 remains within the processing temperature window for the powder of the powder bed fusion system 106 over the length L, L2 of the component 102, 202. For example, the method 400 includes defining the thermal management structure 110 with a greater thickness (at the apex 134, 144) proximate the portion of the component 102 with the smallest wall thickness (at the midsection 128). Similarly, the method 400 includes defining the thermal management structure 216 with the density of the cells 232, the cell wall thickness CW10 and/or the distance D to minimize the temperature gradient proximate the portion of the component 202 with the smallest wall thickness (at the midsection 228). Generally, the method 400 includes defining the thermal management structure 110, 216 layer by layer using the CAD software and the computer aided thermodynamic design tool such that the temperature gradient of the component 102, 202 is minimized and the component 102, 202 remains within the predetermined acceptable processing temperature window over the length L, L2 of the component 102, 202. The model having a number of successive two-dimensional (2D) cross-sectional slices that together form the 3D components 102, 202 and the defined thermal management structure 110, 216 is received by the controller 108 via the buman-machine interface 104, for example. The method 400, at 410, may further include receiving, by the controller 108, the model that includes a number of successive two-dimensional (2D) cross-sectional slices that together form the components 102, 202-214, the box 218, and the thermal management structures 110, 216 with the build box 200 via the human-machine interface 104, for example.

At 412, the method 400 includes outputting one or more control signals, by the controller 108, to additively manufacture the component 102, 202 with the thermal management structure 110, 216 substantially simultaneously using the powder bed fusion system 106, such as the multi jet fusion 3D printer. The method 400 at 412 may further include outputting one or more control signals, by the controller 108, to additively manufacture the components 102, 202-214, the box 218, and the thermal management structures 110, 216 with the build box 200 using the powder bed fusion system 106. The method 400 ends at 414.

Once the additive manufacturing of the component 102, 202 is completed, the components 102, 202-214 and the thermal management structure 110, 216 may be removed from the build box 200. The components 102, 202 may be removed from the respective thermal management structure 110, 216. In the example of the thermal management structure 216, the thermal management structure 216 may be cut to remove the component 202 from the thermal management structure 216.

Thus, the system 100 and the method 400 provide for the additive manufacture of the components 102, 202 with the reduced thermal gradient and also ensure that the components 102, 202 remain within the processing temperature window of the powder in the powder bed fusion system 106 throughout the manufacture of the component 102, 202. Generally, by defining the thermal management structure 110, 216 to provide an increased surface area at locations of the component 102, 202 that have a reduced surface area, the thermal management structure 110, 216 minimizes the thermal gradient that would otherwise occur during manufacturing. It should be noted that in the example of the build box 200, the thermal gradient generated by adjacent components may also be determined, using the computer aided thermodynamic design tool, for example, and the thermal management structure 110, 216 may be defined to ensure that the manufacture of adjacent components 204-214 does not impact the thermal gradient of the component 102, 202.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for additive manufacturing a component, comprising:
the component configured to be additively manufactured using powder bed fusion, the component including a first geometry that is different than a second geometry, the first geometry and the second geometry configured to create a thermal gradient along the component; and
a thermal management structure defined proximate the component, the thermal management structure having a first structure geometry that is different than a second structure geometry, the first structure geometry defined proximate the first geometry and the second structure geometry defined proximate the second geometry, the thermal management structure configured to be additively manufactured with the component substantially simultaneously to reduce the thermal gradient along the component.

2. The system of claim 1, wherein the thermal management structure is a solid structure.

3. The system of claim 2, wherein the first geometry is a first wall thickness, the second geometry is a second wall thickness, the first structure geometry is a first structure wall thickness and the second structure geometry is a second structure wall thickness.

4. The system of claim 3, wherein the first wall thickness is greater than the second wall thickness, and the first structure wall thickness is less than the second structure wall thickness.

5. The system of claim 1, wherein the component defines a central bore, and the thermal management structure includes a first structure positioned within the central bore and a second structure positioned about an outer surface of the component.

6. The system of claim 1, wherein the thermal management structure surrounds at least a portion of an outer surface of the component.

7. The system of claim 1, wherein the thermal management structure encloses the component.

8. The system of claim 1, wherein the thermal management structure is a lattice having a plurality of cells.

9. The system of claim 8, wherein the first geometry is a first wall thickness, the second geometry is a second wall thickness, the first structure geometry is a first density of the plurality of cells and the second structure geometry is a second density of the plurality of cells.

10. The system of claim 9, wherein the first wall thickness is greater than the second wall thickness, and the first density of the plurality of cells is less than the second density of the plurality of cells.

11. The system of claim 8, wherein the first geometry is a first wall thickness, the second geometry is a second wall thickness, the first structure geometry is a first distance defined between at least one of the plurality of cells and the second structure geometry is a second distance defined between at least a second one of the plurality of cells.

12. The system of claim 11, wherein the first wall thickness is greater than the second wall thickness, and the first distance defined between at least one of the plurality of cells is greater than the second distance defined between at least one of the plurality of cells.

13. The system of claim 8, wherein the first geometry is a first wall thickness, the second geometry is a second wall thickness, the first structure geometry is a first cell wall thickness of at least one of the plurality of cells and the second structure geometry is a second cell wall thickness of at least a second one of the plurality of cells.

14. The system of claim 13, wherein the first wall thickness is greater than the second wall thickness, and the first cell wall thickness is less than the second cell wall thickness.

15. The system of claim 1, wherein the powder bed fusion is performed by a multi jet fusion three-dimensional printer, and the component and the thermal management structure are composed of a polymer-based material.

16. A method for additive manufacturing a component, comprising:
receiving, by a processor of a controller, data of the component to be additively manufactured using powder bed fusion, the data including a model of the component, the component including a first geometry different than a second geometry, the first geometry and the second geometry configured to create a thermal gradient along the component;
defining a thermal management structure based on the thermal gradient to reduce the thermal gradient, the thermal management structure defined to surround at least a portion of the component, the thermal management structure having a first structure geometry that is different than a second structure geometry, the first structure geometry defined proximate the first geometry and the second structure geometry defined proximate the second geometry; and
outputting one or more control signals, by the controller, to additively manufacture the component with the thermal management structure using the powder bed fusion.

17. The method of claim 16, wherein the thermal management structure is a solid structure.

18. The method of claim 16, wherein the thermal management structure is a lattice structure.

19. The method of claim 16, wherein the powder bed fusion is performed by a multi jet fusion three-dimensional printer, and the component and the thermal management structure are each comprised of a polymer-based material.

20. The method of claim 16, wherein the first geometry is a first wall thickness, the second geometry is a second wall thickness that is less than the first wall thickness, the first structure geometry is a first structure wall thickness and the second structure geometry is a second structure wall thickness that is greater than the first structure wall thickness.
